(19) United States
(12) Patent Application Publication
(10) Pub. No.: US 2008/0107200 A1
(43) Pub. Date: May 8, 2008

(54) Preamble detection and synchronization in OFDMA wireless communication systems

(75) Inventors: Jie Zhu, Santa Clara, CA (US); Jong Hyeon Park, San Jose, CA (US); Je Woo Kim, San Jose, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: TeleCIS Wireless, Inc.

(21) Appl. No.: 11/982,508

(22) Filed: Nov. 2, 2007

Related U.S. Application Data
(60) Provisional application No. 60/857,528, filed on Nov. 7, 2006.

(51) Int. Cl. H04L 27/28; H04B 1/00; H04J 11/00; H04K 1/10

(52) U.S. Cl. 375/260; 370/210; 370/344; 375/150; 375/343

(57) ABSTRACT

An embodiment of the invention is a technique for preamble detection and synchronization. A symbol correlation of a sequence of symbols is computed in a correlation window using one of a time-domain correlation and a frequency-domain correlation. The sequence of symbols is received in an orthogonal frequency division multiple access (OFDMA) wireless communication. A symbol is verified from the symbol correlation. The symbol is one of a preamble symbol and a data symbol.

### RELATED APPLICATION

This application claims benefit of the Provisional Application, filed on Nov. 7, 2006, Ser. No. 60/857,528, titled, “Preamble detection and synchronization in OFDMA wireless communication systems”.

### BACKGROUND

1. Field of the Invention

Embodiments of the invention are related to Orthogonal Frequency Division Multiple Access (OFDMA) wireless communication systems and more specifically, to preamble detection and synchronization in an OFDMA system.

2. Description of Related Art

Among the various communication transmission techniques, orthogonal frequency division multiplexing (OFDM) has been considered as the most promising candidate because of its resistance to inter-symbol interference, and its high spectrum efficiency.

OFDMA is a multi-user OFDM that allows multiple accesses on the same channel. In an OFDMA Time Division Duplex (TDD) system, the frame structure is built from base station (BS) and mobile subscriber station (MSS) transmissions. The base stations transmit information to their serving mobile subscriber stations via downlink (DL) radio signals. The mobile stations (MS), or subscriber stations (SS), transmit information to their serving base stations via uplink (UL) radio signals. OFDMA distributes subcarriers among users so all active users can transmit and receive at the same time within a single channel.

Based on current defined WiMAX standard, IEEE 802.16E, the first symbol of the downlink transmission is the preamble. This is used for the initial synchronization by the mobile stations. In order to transmit and receive the frames, the base station and the mobile station must acquire mutual synchronization. In order to acquire the mutual synchronization, the MS has to detect the start position of the preamble transmitted from the BS.

/Existing techniques for preamble synchronization have a number of drawbacks. One basic preamble detection scheme is based on the correlation between a cyclic prefix and the last part of OFDM symbol. The symbols inside the cyclic prefix are copied from the last part of OFDM symbol. The position of cyclic prefix may be estimated by calculating the correlation between received sequence and its delayed version. Even though the signal power of preamble is relatively higher than the power of ordinary OFDM data symbol, which means CP correlation from preamble has a higher correlation output, it is still difficult to differentiate preamble from ordinary OFDM data.

One possible solution for this issue is to verify whether the detected CP is from preamble or data symbol. One verification procedure applies for WiMAX standard. In the WiMAX standard, there are 114 pseudo-noise (PN) sequences used for preamble from different base stations and different sectors. The verification may be performed by computing the cross-correlation of the received sequence with all available PN sequences. This technique requires high computational costs in performing the cross-correlation. In addition, the frequency offset estimation based on cyclic prefix cannot remove the integer frequency offset, which cause the modulated sequence to shift from one subcarrier to another subcarrier. This further increases the overall calculations significantly.

Another technique is to perform detection based on the conjugate symmetry in the time domain. This technique requires a large number of complex multiplications for the verification of each position.

Yet another technique is based on the repetition property of preamble. In the WiMAX standard, the preamble sequence is modulated evenly on each 3^{rd} sub-carrier. Signals from one block are correlated with signals from either one of the other two blocks. Although this scheme may be efficient in a single cell environment, it is not effective in a multi-cell environment, because preambles from different base stations are modulated on different sub-carrier sets.

### SUMMARY OF INVENTION

An embodiment of the invention is a technique for preamble detection and synchronization. A symbol correlation of a sequence of symbols is computed in a correlation window using one of a time-domain correlation and a frequency-domain correlation. The sequence of symbols is received in an orthogonal frequency division multiple access (OFDMA) wireless communication. A symbol is verified from the symbol correlation. The symbol is one of a preamble symbol and a data symbol.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating a preamble detector/synchronizer according to one embodiment of the invention.

FIG. 3 is a diagram illustrating time-domain and frequency-domain correlations according to one embodiment of the invention.

FIG. 4 is a diagram illustrating a frequency-domain correlator according to one embodiment of the invention.

FIG. 5 is a diagram illustrating a verifier according to one embodiment of the invention.

FIG. 6 is a flowchart to illustrate a process to detect preamble and synchronize according to one embodiment of the invention.

FIG. 7A is a flowchart to illustrate a process to compute symbol correlation using time-domain correlation according to one embodiment of the invention.

FIG. 7B is a flowchart to illustrate a process to compute symbol correlation using frequency-domain correlation according to one embodiment of the invention.

FIG. 8 is a flowchart to illustrate a process to verify the symbol according to one embodiment of the invention.

FIG. 9 is a diagram illustrating a processing subsystem to implement the preamble detection and synchronization according to one embodiment of the invention.

### DESCRIPTION

An embodiment of the invention is a technique for preamble detection and synchronization. A symbol correlation of a sequence of symbols is computed in a correlation window using one of a time-domain correlation and a frequency-domain correlation. The sequence of symbols is received in an orthogonal frequency division multiple access (OFDMA) wireless communication. A symbol is verified from the symbol correlation. The symbol is one of a preamble symbol and a data symbol.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

Embodiments of the invention include a time synchronization acquisition method in an OFDMA wireless communication system. The method includes two phases: the first phase is used for OFDM symbol coarse boundary detection based on cyclic prefix correlation; and the second phase is used to verify whether the current symbol is an OFDM preamble symbol or an OFDM data symbol. The second phase may also be used to estimate fine symbol boundary. The verification procedure is based on the conjugate symmetry of the Binary Phase Shift Keying (BPSK) modulated OFDM preamble. There are two alternative approaches for the procedure: a time domain processing scheme and a frequency domain processing scheme. To determine whether the current symbol is BPSK modulated OFDM symbol, both the maximum of correlation output and the sum of a number of maximum correlation outputs are compared with their corresponding preset thresholds. Moreover, the second phase can be applied to the signal detection and symbol boundary estimation of BPSK modulated OFDM symbols.

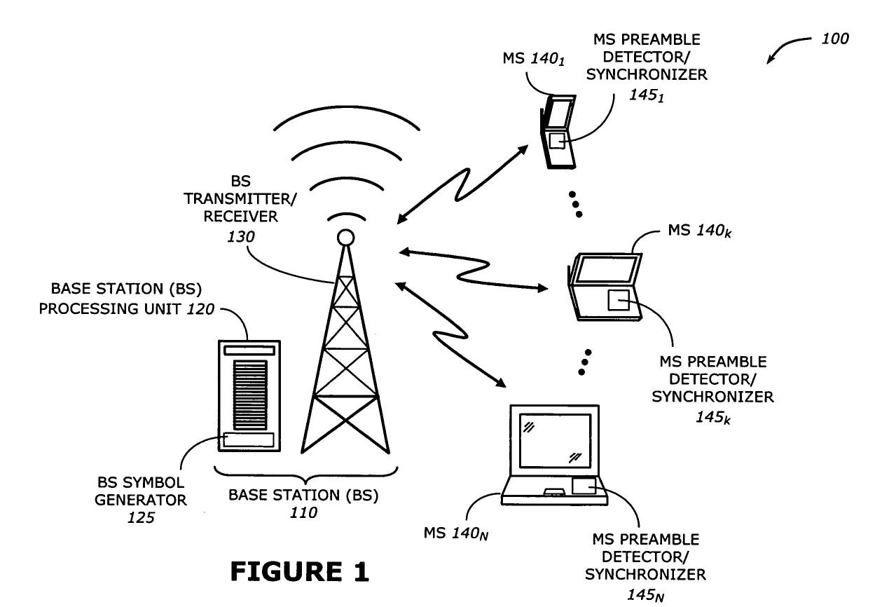

FIG. 1 is a diagram illustrating a system 100 according to one embodiment of the invention. The system 100 includes a base station (BS) 110 and N mobile stations (MSs) 140₁ to 140_{N}. Note that the system 100 may include more or less than the above components.

The BS 110 is a station installed at a fixed or mobile location to communicate with the N MSs 140₁ to 140_{N} in a wireless communication mode via radio frequency (RF) transmission. The wireless communication may conform to a Worldwide Interoperability for Microwave Access (WiMAX) standard. The location may be at a sparsely or densely populated area, or may be for vehicular uses. The BS 110 includes a BS processing unit 120 and a BS transmitter/receiver 130.

The BS processing unit 120 includes necessary components for BS operations. It may include an oscillator to provide clock sources or signals to various components in the unit, such as analog-to-digital converter (ADC), digital-to-analog converter (DAC), and other logic circuits; one or more processors such as digital signal processor (DSP), to perform various functions or execute programs; automatic gain control (AGC), automatic frequency control (AFC), and channel encoding/decoding modules or circuits, etc. The BS processing unit 120 includes a BS symbol generator 125 to generate sequence of symbols for transmission to the N MSs 140₁ to 140_{N}.

The BS transmitter/receiver 130 may include transmitting unit and receiving unit to transmit and receive RF signals. It may include a high powered antenna. The antenna may be mounted on a rooftop, tower, or hilltop depending on the type or terrain and the desired coverage area.

The N MSs 140₁ to 140_{N} may include any MS device such as a handset, a cellular phone, a personal digital assistant (PDA), a notebook computer, a laptop computer, or any device that is capable of performing MS functionality in a wireless communication network. Each of the N MSs 140₁ to 140_{N} may subscribe for mobile communication services provided by the BS 110. Each of the N MSs 140₁ to 140_{N} may include a radio frequency (RF) receiver to receive a radio signal carrying a sequence of symbols from the BS 110 in an orthogonal frequency division multiple access (OFDMA) wireless communication, a preamble detector and synchronizer 145ᵢ (i=1, . . . , N) to detect a preamble symbols and synchronize frames, a cyclic prefix (CP) remover to remove the CP, a fast Fourier Transform (FFT) processor to compute the FFT, a channel equalizer, a channel estimator, a decoder, a de-interleaver, and other circuits or modules to perform receiving functions. Each of the N MSs 140₁ to 140_{N} may also include channel coder and interleaver, Binary Phase Shift Keying (BPSK) mapper, inverse FFT (IFFT) processor, cyclic prefix and windowing processing unit, and RF transmitter, and other circuits or modules to perform transmitting functions.

The BS 110 and the N MSs 140₁ to 140_{N} communicate with one another under a predefined communication protocol or standard. In one embodiment, the communication standard is the Institute of Electrical and Electronics Engineers (IEEE) 802.16e standard or European Telecommunications Standards Institute (ETSI) High Performance Radio Metropolitan Area Network (HiperMAN) 1.3.2 standard. The MS preamble detector/synchronizer 145ᵢ provides an efficient detection of preamble for frame synchronization. The BS 110 and the N MSs 140₁ to 140_{N} may include Medium Access Control (MAC) and Physical layer (PHY) features in a typical WiMAX system. The WiMAX system uses the Orthogonal Frequency Division Multiple Access (OFDMA) scheme for multi-path environments.

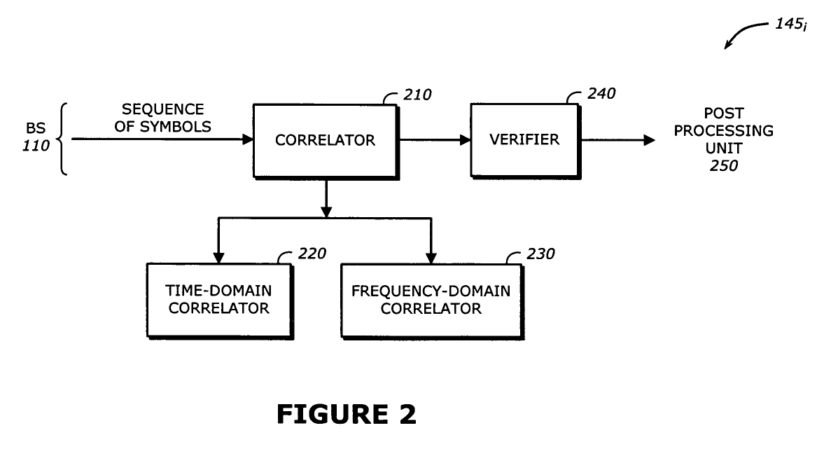

FIG. 2 is a diagram illustrating a preamble detector/synchronizer 145ᵢ according to one embodiment of the invention. For brevity, the subscript “I” may be dropped. The preamble detector/synchronizer 145 includes a correlator 210 and a verifier 240. The preamble detector/synchronizer 145 may include more or less than the above components. In addition, it may be implemented by hardware, firmware, or software or any combination of them.

The correlator 210 computes a symbol correlation of a sequence of symbols in a correlation window L using one of a time-domain correlator 220 and a frequency-domain correlator 230. The sequence of symbols is received in an OFDMA wireless communication. The sequence of symbols may represent any symbols generated by a transmitting device (e.g., the BS 110). The symbols may form a cyclic prefix (CP) used in the preamble, or may represent the data symbols that are part of a communication message.

The time-domain correlator 220 computes the symbol correlation in the time domain using a conjugate symmetry sequence within a verification window K. The verification window being smaller than the correlation window, i.e., its length is shorter than the correlation window L. The verification window K may be represented by the minimum index −K_{w} and the maximum index K_{w} where the window length K=2K_{w}+1. For example, if K_{w}=3, then the verification window K has indices of −3, −2, −1, 0, 1, 2, 3.

The frequency-domain correlator 230 computes the symbol correlation in the frequency domain by converting the correlation to a circular convolution. A circular convolution may be computed in the time domain or in the frequency domain. The frequency domain convolution is more efficient due to the availability of the fast Fourier Transform (FFT) for fast computation of the Fourier Transform (FT). Moreover, the FFT computation is typically already available in the receiver of the MS 140. Therefore, no additional hardware or software may be needed for FFT computations.

The verifier 240 is coupled to the correlator 210 to verify a symbol from the symbol correlation. The symbol is one of a preamble symbol and a data symbol. If it is a preamble symbol, frame synchronization may be obtained.

The detected symbol, whether preamble symbol or data symbol, may then be processed by a post processing unit 250. The post processing unit 250 may include other components of the receiver in the MS 140 to perform receiver tasks such as CP removal, data recovery using FFT, channel equalization, channel estimation, decoding, de-interleaving, etc.

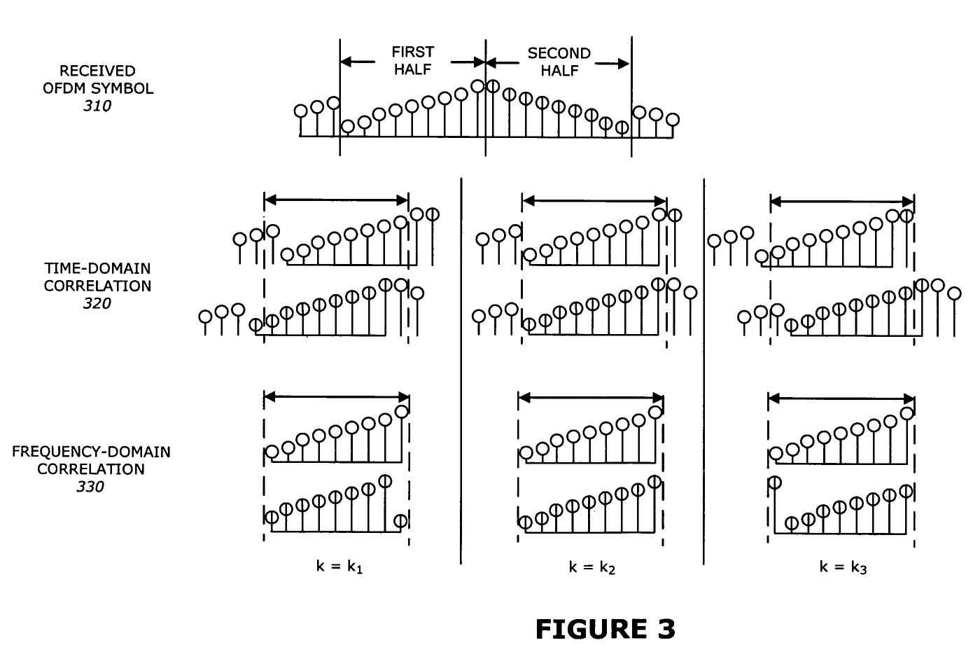

FIG. 3 is a diagram illustrating time-domain and frequency-domain correlations 320 and 330 according to one embodiment of the invention. The correlations are performed on a received sequence of symbols 310.

Given a sequence x(n), the correlation of the sequence x(n) is computed according to the following:

$${R}_{x} ( n ) = {\sum }_{n = 0}^{{N}_{g} - 1} x ( n ) \cdot {x}^{*} ( n + {N}_{FFT} ) \qquad ( 1 )$$

where x(n) is the received sequence in the time domain and N_{FFT} is the number of points in the FFT computation.

The conjugate symmetry in the time domain may be described as:

y(n)=y*(N_{FFT}−n) (2)

Where y* is complex conjugate of y.

From this, the preamble detection based on the conjugate symmetry may be modeled as:

$${r}_{cs} ( k ) = \vert {\sum }_{n = 1}^{n = L} y ( k + n ) \cdot y ( k + {N}_{FFT} - n ) \vert \qquad ( 3 )$$

where L is the length or size of the correlation window, which is less than N_{FFT}/2.

In the time-domain correlation, assume no is the start position of the useful part of the sequence of symbols obtained from the CP-based detection, equation (3) may be modified as:

$${r}_{CS} ( {n}_{0} + k ) = \vert {\sum }_{n = 1}^{n = L} y ( {n}_{0} + k + n ) \cdot y ( {n}_{0} + k + {N}_{FFT} - n ) \vert \qquad ( 4 )$$

where k=−K_{W}, . . . , K_{W} and K=2K_{W}+1 is the length of the verification window.

The time-domain correlation therefore only computes (2K_{W}+1) conjugate symmetry correlations instead of the entire L conjugate symmetry correlations. Accordingly, the number of computations is less than the standard technique.

The time-domain correlation computes the symbol correlation using equation (4). This computation may be illustrated pictorially by the time-domain correlation 320 shown in FIG. 3. In the time-domain correlation 320, both the received sequence and its conjugate symmetry are shifted in the opposite directions.

In the frequency-domain correlation, the correlation given in equation (4) may be converted to a circular convolution as follows. Equation (4) may be regarded as the correlation of two sequences S1 and S2. For each different value of k, sequence S1 may be shifted to the left or right, while S2 may be shifted to the right or left, based on the sign of k. However, most elements in different sequence are the same when k is much less than L. Based on this observation, equation (4) may be approximated as

$${r}_{CS} ( {n}_{0} + k ) \approx \vert {\sum }_{n = 1}^{n = L} x ( {n}_{0} + n ) \cdot x ( {〈 {n}_{0} + k + {N}_{FFT} - n 〉}_{L} ) \vert \qquad ( 5 )$$

where [symbol] denotes modulo L.

From equation (5), it can be seen that sequence S1 is fixed for different value of k, while sequence S2 is circularly shifted based on the value of k. This may be illustrated pictorially by the frequency-domain correlation 330.

Equation (5) may be considered as circular convolution of two sequences. Without loss of generality, no may be assumed zero for simplicity. The sequences S1 and S2 may be rewritten as:

S1=[x(1)x(2) . . . x(L)], (6a)

S2=[x(N_{FFT}−1)x(N_{FFT}−2) . . . x(N_{FFT}−L)], (6b)

R_{CS}=[r_{CS}(1)r_{CS}(2) . . . r_{CS}(L)], (6c)

where R_{CS} is the convolution of S1 and S2. Then,

R_{cs}≈S1 [symbol] S2=IFFT(FFT(S1)·(FFT(S2*))*) (7)

S1 is a first sequence in the sequence of symbols x(n)=[x(1) x(2) . . . , x(N_{FFT}−1), x(N_{FFT})]. S2 is a re-ordered sequence of a second sequence S′2=[X(N_{FFT}−L), x(N_{FFT}−(L+1)) . . . , x(N_{FFT}−1), x(N_{FFT})]. It is noted that although the frequency-domain correlation uses two FFTs and one IFFT, it does not introduce additional computational effort for the receiver in the MS 140 because the FFT and IFFT operations are already implemented in the OFDM transceiver.

In addition, the frequency-domain correlation increases the verification window size without increasing computational complexity. In the time-domain correlation, the computation complexity is proportional to the verification window size of K_{w}. In the frequency domain correlation, the verification window size may be as large as L/4.

Furthermore, the frequency-domain correlation technique increases the processing gain at a relatively low complexity cost. The processing gain is proportional to the correlation window size of L. When window size is increased from L to 2L, the time domain processing algorithm requires additional (2K_{W}+1) L complex multiplications, while the frequency domain correlation technique only requires additional L complex multiplications. As discussed above, the additional operations related with FFT/IFFT may be ignored because they do not introduce new hardware for the receiver.

Moreover, the correlation techniques in embodiments of the invention provide accurate symbol boundary estimation without additional cost. The conventional boundary estimation is based on cyclic prefix, where the correlation function is a triangle. The boundary is estimated based on the position of the triangle peak. Because of different interferences, the boundary estimation is not very accurate. On the other hand, the correlation based on conjugate symmetry is a delta function, which means the timing metric has a much higher peak value at correct symbol timing position than those at other positions. Therefore, it may provide much more accurate boundary estimation than a CP-based scheme.

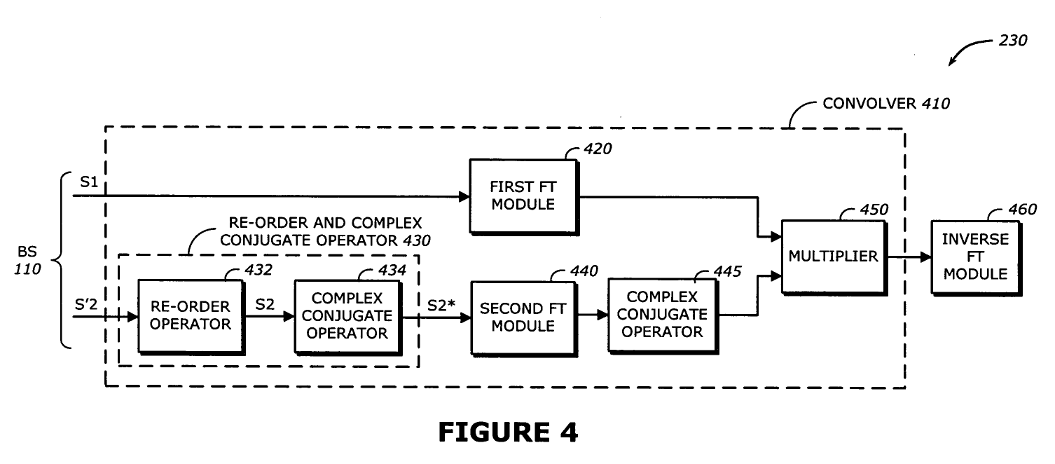

FIG. 4 is a diagram illustrating the frequency-domain correlator 230 shown in FIG. 2 according to one embodiment of the invention. The frequency-domain correlator 230 includes a convolver 410 and an inverse FT module 460. The frequency-domain correlator 230 may include more or less than the above components.

The frequency-domain convolver 410 computes a frequency-domain circular convolution of the sequence of symbols. It includes a first FT module 420, a re-ordering and complex conjugate operator 430, a second FT module 440, a complex conjugate operator 445 and a multiplier 450. The first FT module 420 computes a first FT sequence of a first sequence S1 in the sequence of symbols having a length of the correlation window L. The re-ordering and complex conjugate operator 430 performs a re-ordering and complex conjugate operation on a second sequence S′2 in the sequence of symbols. It may include an index mapper that maps the index to a symmetry index as shown in equations (6b) and (7). The second FT module 440 computes a second FT sequence of the re-ordered and complex conjugated second sequence having a length of the correlation window L. The complex conjugate operator 445 performs a complex conjugate operation on the output of the second FT 440. The multiplier 450 multiplies the first FT sequence and the complex conjugated second FT sequence to provide the frequency-domain circular convolution.

The inverse Fourier Transform (FT) module 460 is coupled to the convolver 410 to compute an inverse Fourier Transform (FT) of the circular convolution to provide the symbol correlation. Typically, the first and second FT modules employ the FFT to perform the FT computations. The inverse FT module 460 employs the IFFT to perform the inverse FT computation.

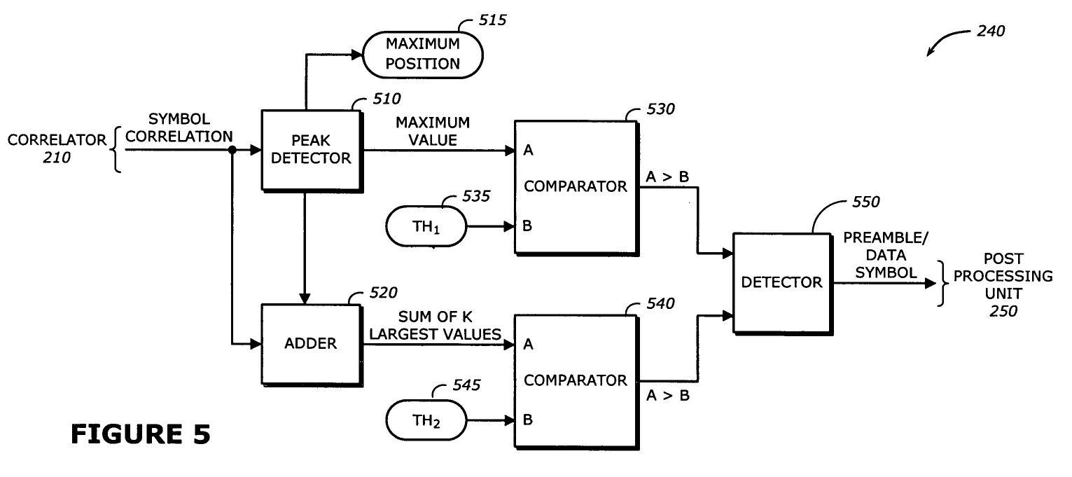

FIG. 5 is a diagram illustrating the verifier 240 shown in FIG. 2 according to one embodiment of the invention. The verifier 240 includes a peak detector 510, an adder 520, first and second comparators 530 and 540, and a detector 550. The verifier 240 may include more or less than the above components.

The peak detector 510 determines a maximum value of the symbol correlation at a maximum position k₀ 515. The peak detector 510 also determines K largest values in the symbol correlation where K is a pre-determined positive integer. The peak detector 510, therefore, may be used to perform two functions: one is to determine the maximum value and one is to determine K largest values which include the maximum value. The adder 520 computes a sum of the K largest values of the symbol correlation. The K largest values have the maximum value at the maximum position k₀ 515. The first comparator 530 compares the maximum value with a first threshold TH₁ 535. The second comparator 540 compares the sum with a second threshold TH₂ 545.

The detector 550 may detect the symbol as the preamble symbol at the maximum position k₀ if the maximum value exceeds the first threshold TH₁. When k₀≦L/2, the index corresponding to the start position of the preamble useful part is on the right side of detected symbol boundary based on CP-based detection, or the index is (n₀+k₀/2). When k₀>L/2, the index corresponding to the start position of the preamble useful part is on the left side of detected symbol boundary based on CP-based detection, or the index is (n₀−(L−k₀)/2). The detector 550 may also detect the symbol as the preamble symbol if the sum exceeds the second threshold TH₂. The start position is calculated based on k₀ as in the first threshold case.

The detector 550 may detect the symbol as the data symbol or declare a verification failure if the maximum value does not exceed the first threshold TH₁ 535 and the sum does not exceed the second threshold TH₂ 545. The detector 550 may be a logic circuit that declares the symbol being detected as the preamble symbol if at least one of the comparators 530 and 540 indicates that either the maximum value is greater than TH₁ or the sum is greater than TH₂. If both of the comparators 530 and 540 indicate that none of the thresholds is exceeded, then it declares the verification is failed, or a preamble symbol is not detected.

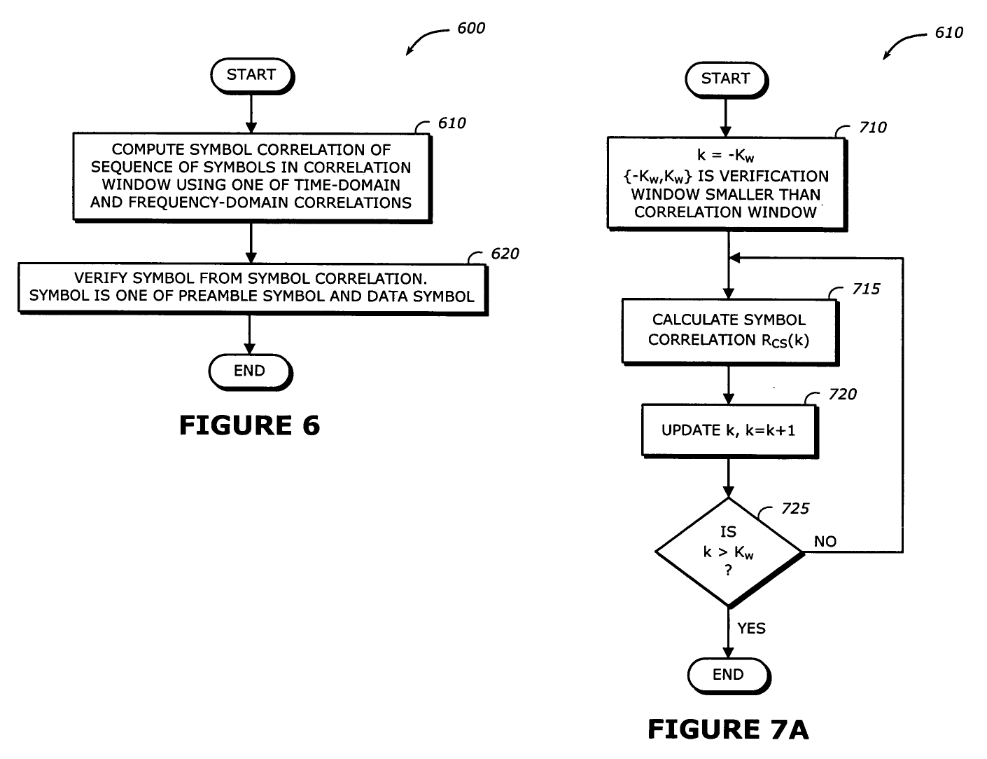

FIG. 6 is a flowchart to illustrate a process 600 to detect preamble and synchronize according to one embodiment of the invention.

Upon START, the process 600 computes a symbol correlation of a sequence of symbols in a correlation window L using one of a time-domain correlation and a frequency-domain correlation (Block 610). The sequence of symbols is received in an orthogonal frequency division multiple access (OFDMA) wireless communication. Next, the process 600 verifies a symbol from the symbol correlation (Block 620) and is then terminated. The symbol is one of a preamble symbol and a data symbol. The verification is to verify if there is a preamble symbol in the sequence. If no preamble is detected, the verification produces a fail result and the process waits for the next detection time.

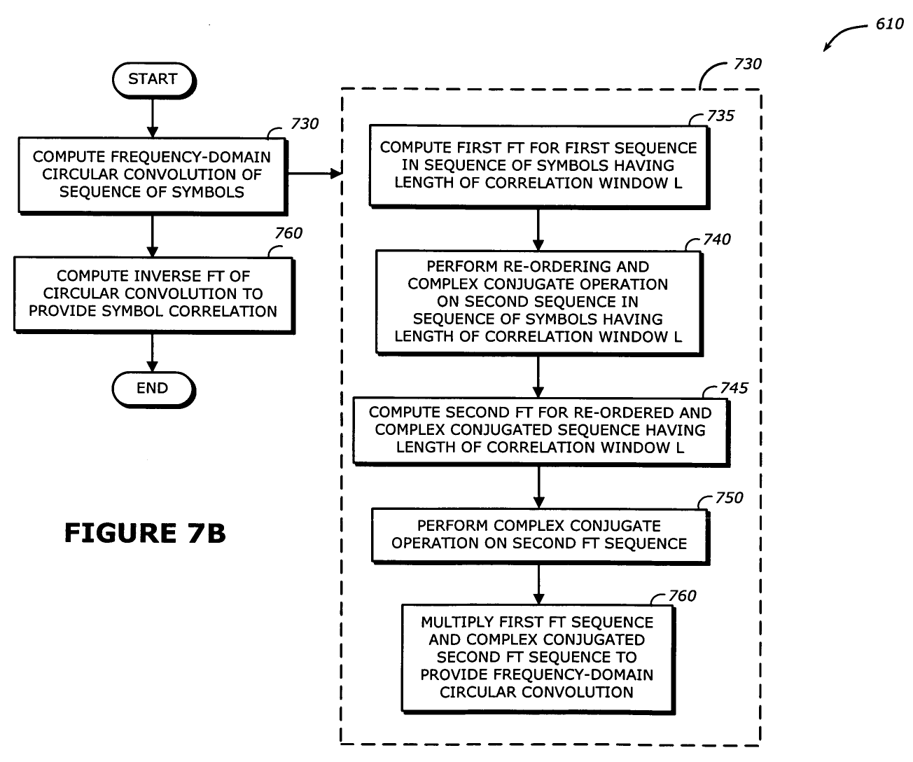

FIG. 7A is a flowchart to illustrate the process 610 shown in FIG. 6 to compute symbol correlation using time-domain correlation according to one embodiment of the invention. The process 610 computes the symbol correlation using a conjugate symmetry sequence within a verification window K. The verification window K is smaller than the correlation window L.

Upon START, the process 610 initializes the index k to −Kw (Block 710). Next, the process 610 calculates the symbol correlation R_{CS}(k) using the equation (4) (Block 715). Then, the process 610 updates the index k, e.g., sets k=k+1 (Block 720). Next, the process 610 determines if k exceeds the largest index KW (Block 725). If not, the process 610 returns to Block 715 to continue calculate the symbol correlation. Otherwise, the process 610 is terminated.

FIG. 7B is a flowchart to illustrate the process 610 shown in FIG. 6 to compute symbol correlation using frequency-domain correlation according to one embodiment of the invention.

Upon START, the process 610 computes a frequency-domain circular convolution of the sequence of symbols. (Block 730). Next, the process 610 computes an inverse Fourier Transform (FT) of the circular convolution to provide the symbol correlation (Block 760) and is then terminated.

The process 730 may be performed as follows. First, the process 730 computes a first FT sequence of a first sequence in the sequence of symbols having a length of the correlation window L (Block 735). The first sequence is the sequence S1 shown in equation (6a). Next, the process 730 determines a re-ordered and complex conjugated of a second sequence in the sequence of symbols (Block 740). The second sequence is the S′2 sequence. This may involve performing a re-ordering index mapping on the second sequence and complex conjugate operation for the re-ordered second sequence. The re-ordered second sequence is the sequence S2 in equation (6b). Then, the process 730 computes a second FT sequence of the re-ordered and complex conjugated second sequence having a length of the correlation window L (Block 745). Next, the process 730 performs a complex conjugate operation on the second FT sequence (Block 750). Then, the process 730 multiplies the first FT sequence and the complex conjugated second FT sequence to provide the frequency-domain circular convolution (Block 750) and is then terminated.

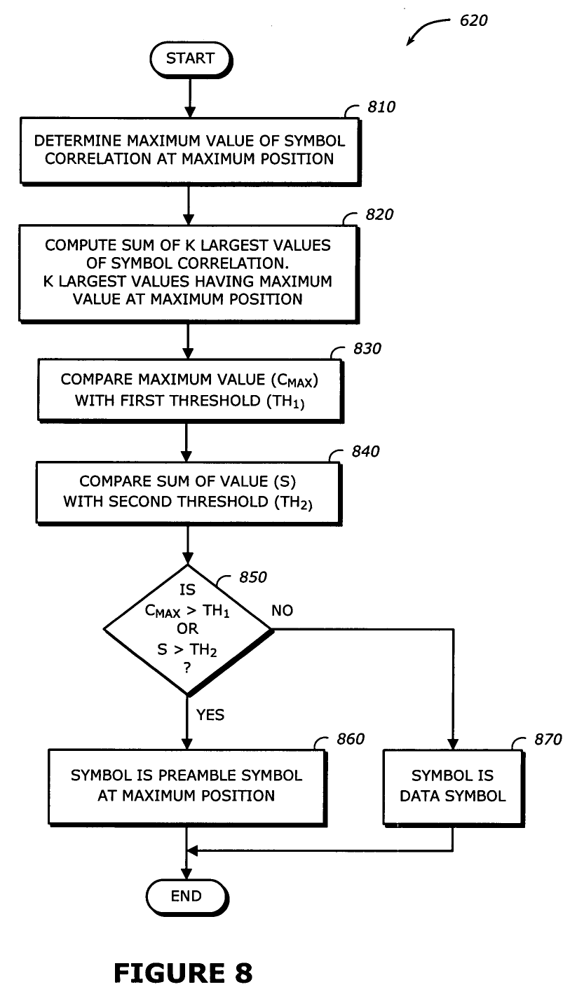

FIG. 8 is a flowchart to illustrate the process 620 shown in FIG. 6 to verify the symbol according to one embodiment of the invention.

Upon START, the process 620 determines a maximum value Cₘₐₓ of the symbol correlation at a maximum position k₀ (Block 810). Next, the process 620 computes a sum of values S of the symbol correlation at positions around a center position k_{c} (Block 820). Then, the process 620 compares the maximum value with a first threshold TH₁ (Block 830). Next, the process 620 compares the sum with a second threshold TH₂ (Block 840). Note that the order of Blocks 830 and 840 is immaterial.

Then, the process 620 determines if the maximum value Cₘₐₓ is greater than the first threshold TH₁ or the sum S is greater than the second threshold TH₂ (Block 850). If so, the process 620 determines the symbol as the preamble symbol at the maximum position k₀ (if Cₘₐₓ is greater than the first threshold TH₁) or at the center position (if the sum S is greater than the second threshold TH₂) and is then terminated. Otherwise, i.e., if the maximum value Cₘₐₓ does not exceed the first threshold and the sum S does not exceed the second threshold, the process 620 determines the symbol as the data symbol or declares a verification failure. The process 620 is then terminated.

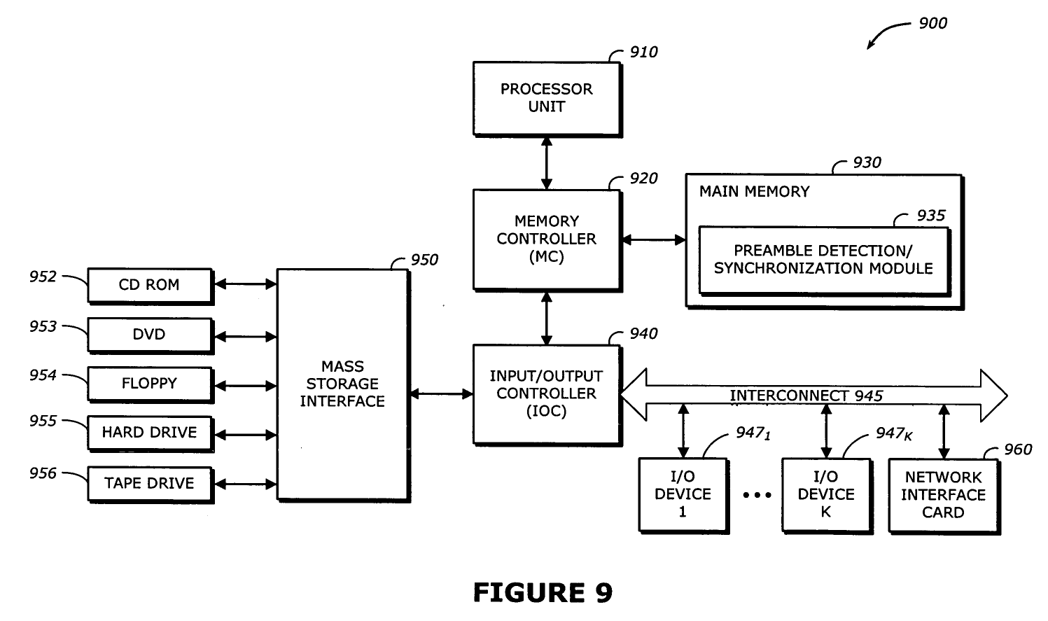

FIG. 9 is a diagram illustrating a processing unit 900 to implement the preamble detection and synchronization 145ᵢ shown in FIG. 1 according to one embodiment of the invention. The processing unit 900 includes a processor 910, a memory controller (MC) 920, a main memory 930, an input/output controller (IOC) 940, an interconnect 945, a mass storage interface 950, input/output (I/O) devices 947₁ to 947_{K}, and a network interface card (NIC) 960. The processing unit 900 may include more or less of the above components.

The processor 910 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 920 provides control and configuration of memory and input/output devices such as the main memory 930 and the IOC 940. The MC 920 may be integrated into a chipset that integrates multiple functionalities such as graphics, media, isolated execution mode, host-to-peripheral bus interface, memory control, power management, etc. The MC 920 or the memory controller functionality in the MC 920 may be integrated in the processor unit 910. In some embodiments, the memory controller, either internal or external to the processor unit 910, may work for all cores or processors in the processor unit 910. In other embodiments, it may include different portions that may work separately for different cores or processors in the processor unit 910.

The main memory 930 stores system code and data. The main memory 930 is typically implemented with dynamic random access memory (DRAM), static random access memory (SRAM), or any other types of memories including those that do not need to be refreshed. The main memory 930 may include multiple channels of memory devices such as DRAMs. The DRAMs may include Double Data Rate (DDR2) devices with a bandwidth of 8.5 Gigabyte per second (GB/s). In one embodiment, the memory 930 may include a preamble detection/synchronization module 935. The preamble detection/synchronization module 935 may perform all or some of the functions described above.

The IOC 940 has a number of functionalities that are designed to support I/O functions. The IOC 940 may also be integrated into a chipset together or separate from the MC 920 to perform I/O functions. The IOC 940 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 945 provides interface to peripheral devices. The interconnect 945 may be point-to-point or connected to multiple devices. For clarity, not all interconnects are shown. It is contemplated that the interconnect 945 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 950 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include high-capacity high speed storage arrays, such as Redundant Array of Inexpensive Disks (RAIDs), Network Attached Storage (NAS), digital tapes, optical storage, etc.

The mass storage device may include compact disk (CD) read-only memory (ROM) 952, digital video/versatile disc (DVD) 953, floppy drive 954, hard drive 955, tape drive 956, and any other magnetic or optic storage devices. The mass storage device provides a mechanism to read machine-accessible media.

The I/O devices 947₁ to 947_{K} may include any I/O devices to perform I/O functions. Examples of I/O devices 947₁ to 947_{K} include controller for input devices (e.g., keyboard, mouse, trackball, pointing device), media card (e.g., audio, video, graphic), and any other peripheral controllers.

The NIC 960 provides network connectivity to the processing unit 230. The NIC 960 may generate interrupts as part of the processing of communication transactions. In one embodiment, the NIC 960 is compatible with both 32-bit and 64-bit peripheral component interconnect (PCI) bus standards. It is typically compliant with PCI local bus revision 2.2, PCI-X local bus revision 1.0, or PCI-Express standards. There may be more than one NIC 960 in the processing system. Typically, the NIC 960 supports standard Ethernet minimum and maximum frame sizes (64 to 6518 bytes), frame format, and Institute of Electronics and Electrical Engineers (IEEE) 802.2 Local Link Control (LLC) specifications. It may also support full-duplex Gigabit Ethernet interface, frame-based flow control, and other standards defining the physical layer and data link layer of wired Ethernet. It may support copper Gigabit Ethernet defined by IEEE 802.3ab or fiber-optic Gigabit Ethernet defined by IEEE 802.3z.

The NIC 960 may also be a host bus adapter (HBA) such as a Small Computer System Interface (SCSI) host adapter or a Fiber Channel (FC) host adapter. The SCSI host adapter may contain hardware and firmware on board to execute SCSI transactions or an adapter Basic Input/Output System (BIOS) to boot from a SCSI device or configure the SCSI host adapter. The FC host adapter may be used to interface to a Fiber Channel bus. It may operate at high speed (e.g., 2 Gbps) with auto speed negotiation with 1 Gbps Fiber Channel Storage Area Network (SANs). It may be supported by appropriate firmware or software to provide discovery, reporting, and management of local and remote HBAs with both in-band FC or out-of-band Internet Protocol (IP) support. It may have frame level multiplexing and out of order frame reassembly, on-board context cache for fabric support, and end-to-end data protection with hardware parity and cyclic redundancy code (CRC) support.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. A hardware implementation may include circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code embedded therein. The program code may include machine readable code to perform the operations or actions described above. The term “information” or “data” here refers to any type of information that is encoded for machine-readable purposes. Therefore, it may include program, code, data, file, etc.

All or part of an embodiment of the invention may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
computing a symbol correlation of a sequence of symbols in a correlation window using one of a time-domain correlation and a frequency-domain correlation, the sequence of symbols being received in an orthogonal frequency division multiple access (OFDMA) wireless communication; and
verifying a symbol from the symbol correlation, the symbol being one of a preamble symbol and a data symbol.

2. The method of claim 1 wherein computing the symbol correlation using the time-domain correlation comprises:
computing the symbol correlation using a conjugate symmetry sequence within a verification window, the verification window being smaller than the correlation window.

3. The method of claim 1 wherein computing the symbol correlation using the frequency-domain correlation comprises:
computing a frequency-domain circular convolution of the sequence of symbols; and
computing an inverse Fourier Transform (FT) of the circular convolution to provide the symbol correlation.

4. The method of claim 3 wherein computing the frequency-domain circular convolution comprises:
computing a first FT sequence of a first sequence in the sequence of symbols having a length of the correlation window;
performing a re-ordering and complex conjugate operation on a second sequence in the sequence of symbols;
computing a second FT sequence of the re-ordered and complex conjugated second sequence having a length of the correlation window;
performing a complex conjugate operation on the second FT sequence; and
multiplying the first FT sequence and the complex conjugated second FT sequence to provide the frequency-domain circular convolution.

5. The method of claim 1 wherein verifying the symbol comprises:
determining a maximum value of the symbol correlation at a maximum position;
computing a sum of K largest values of the symbol correlation, the K largest values having the maximum value at the maximum position;
comparing the maximum value with a first threshold;
comparing the sum with a second threshold;
if the maximum value exceeds the first threshold or the sum exceeds the second threshold, determining the symbol as the preamble symbol at the maximum position,
else if the maximum value does not exceed the first threshold and the sum does not exceed the second threshold, determining the symbol as the data symbol.

6. The method of claim 4 wherein computing one of the first and second FT sequences comprises computing the one of the first and second FT sequences using a Fast Fourier Transform (FFT).

7. The method of claim 3 wherein computing the inverse FT comprises:
computing the inverse FT using an inverse Fast Fourier Transform (IFFT).

8. An apparatus comprising:
a correlator to compute a symbol correlation of a sequence of symbols in a correlation window using one of a time-domain correlator and a frequency-domain correlator, the sequence of symbols being received in an orthogonal frequency division multiple access (OFDMA) wireless communication; and
a verifier coupled to the correlator to verify a symbol from the symbol correlation, the symbol being one of a preamble symbol and a data symbol.

9. The apparatus of claim 8 wherein the time-domain correlator computes the symbol correlation using a conjugate symmetry sequence within a verification window, the verification window being smaller than the correlation window.

10. The apparatus of claim 8 wherein the frequency-domain correlator comprises:
a frequency-domain convolver to compute a frequency-domain circular convolution of the sequence of symbols; and
an inverse Fourier Transform (FT) module coupled to the convolver to compute an inverse Fourier Transform (FT) of the circular convolution to provide the symbol correlation.

11. The apparatus of claim 10 wherein the convolver comprises:
a first FT module to compute a first FT sequence of a first sequence in the sequence of symbols having a length of the correlation window;
a first complex conjugate operator to perform a re-ordering and a complex conjugate operation on a second sequence in the sequence of symbols;
a second FT module to compute a second FT sequence of the re-ordered and complex conjugated second sequence having a length of the correlation window;
a second complex conjugate operator to perform a complex conjugate operation on the second FT sequence; and
a multiplier to multiply the first FT sequence and the complex conjugated second FT sequence to provide the frequency-domain circular convolution.

12. The apparatus of claim 8 wherein the verifier comprises:
a peak detector to determine a maximum value of the symbol correlation at a maximum position;
an adder to compute a sum of K largest values of the symbol correlation, the K largest values having the maximum value at the maximum position;
a first comparator to compare the maximum value with a first threshold;
a second comparator to compare the sum with a second threshold;
a detector to detect the symbol as the preamble symbol at the maximum position if the maximum value exceeds the first threshold or if the sum exceeds the second threshold, and to detect the symbol as the data symbol if the maximum value does not exceed the first threshold and the sum does not exceed the second threshold.

13. An article of manufacture comprising:
a machine-accessible medium including data that, when accessed by a machine, causes the machine to perform operations comprising:
computing a symbol correlation of a sequence of symbols in a correlation window using one of a time-domain correlation and a frequency-domain correlation, the sequence of symbols being received in an orthogonal frequency division multiple access (OFDMA) wireless communication; and
verifying a symbol from the symbol correlation, the symbol being one of a preamble symbol and a data symbol.

14. The article of manufacture of claim 13 wherein the data causing the machine to perform computing the symbol correlation using the time-domain correlation comprises data that, when accessed by the machine, causing the machine to perform operations comprising:
computing the symbol correlation using a conjugate symmetry sequence within a verification window, the verification window being smaller than the correlation window.

15. The article of manufacture of claim 13 wherein the data causing the machine to perform computing the symbol correlation using the frequency-domain correlation comprises data that, when accessed by the machine, causing the machine to perform operations comprising:
computing a frequency-domain circular convolution of the sequence of symbols; and
computing an inverse Fourier Transform (FT) of the circular convolution to provide the symbol correlation.

16. The article of manufacture of claim 15 wherein the data causing the machine to perform computing the frequency-domain circular convolution comprises data that, when accessed by the machine, causes the machine to perform operations comprising:
computing a first FT sequence of a first sequence in the sequence of symbols having a length of the correlation window;
performing a re-ordering and complex conjugate operations on a second sequence in the sequence of symbols;
computing a second FT sequence of the re-ordered and complex conjugated second sequence having a length of the correlation window;
performing a complex conjugate operation on the second FT sequence; and
multiplying the first FT sequence and the complex conjugated second FT sequence to provide the frequency-domain circular convolution.

17. The article of manufacture of claim 13 wherein the data causing the machine to perform verifying the symbol comprises data that, when accessed by the machine, causes the machine to perform operations comprising:
determining a maximum value of the symbol correlation at a maximum position;
computing a sum of K largest values of the symbol correlation, the K largest values having the maximum value at the maximum position;
comparing the maximum value with a first threshold;
comparing the sum with a second threshold;
if the maximum value exceeds the first threshold or the sum exceeds the second threshold, determining the symbol as the preamble symbol at the maximum position.
else if the maximum value does not exceed the first threshold and the sum does not exceed the second threshold, determining the symbol as the data symbol.

18. An apparatus comprising:
means for computing a symbol correlation of a sequence of symbols in a correlation window using one of a time-domain correlation and a frequency-domain correlation, the sequence of symbols being received in an orthogonal frequency division multiple access (OFDMA) wireless communication; and
means for verifying a symbol from the symbol correlation, the symbol being one of a preamble symbol and a data symbol.

19. The apparatus of claim 18 wherein the means for computing the symbol correlation using the time-domain correlation comprises:
means computing the symbol correlation using a conjugate symmetry sequence within a verification window, the verification window being smaller than the correlation window.

20. The apparatus of claim 18 wherein the means for computing the symbol correlation using the frequency-domain correlation comprises:
means for computing a frequency-domain circular convolution of the sequence of symbols; and
means for computing an inverse Fourier Transform (FT) of the circular convolution to provide the symbol correlation.

21. The apparatus of claim 20 wherein the means for computing the frequency-domain circular convolution comprises:
means for computing a first FT sequence of a first sequence in the sequence of symbols having a length of the correlation window;
means for performing a re-ordering and complex conjugate operation on a second sequence in the sequence of symbols;
means for computing a second Fr sequence of re-ordered and complex conjugated sequence having a length of the correlation window;
means for performing a complex conjugate operation on the second FT sequence; and
means for multiplying the first FT sequence and the complex conjugated second FT sequence to provide the frequency-domain circular convolution.

22. The apparatus of claim 18 wherein the means for verifying the symbol comprises:
means for determining a maximum value of the symbol correlation at a maximum position;
means for computing a sum of K largest values of the symbol correlation, the K largest values having the maximum value at the maximum position;
means for comparing the maximum value with a first threshold;
means for comparing the sum with a second threshold;
means for determining the symbol as the preamble symbol at the maximum position if the maximum value exceeds the first threshold or the sum exceeds the second threshold; and
means for determining the symbol as the data symbol if the maximum value does not exceed the first threshold and the sum does not exceed the second threshold.

23. A mobile station (MS) comprising:
a radio frequency (RF) receiver to receive a radio signal carrying a sequence of symbols from a base station (BS) in an orthogonal frequency division multiple access (OFDMA) wireless communication; and
a preamble detector and synchronizer coupled to the RF receiver, the preamble detector and synchronizer comprising:
a correlator to compute a symbol correlation of the sequence of symbols in a correlation window using one of a time-domain correlator and a frequency-domain correlator, and
a verifier coupled to the correlator to verify a symbol from the symbol correlation, the symbol being one of a preamble symbol and a data symbol.

24. The MS of claim 23 wherein the time-domain correlator computes the symbol correlation using a conjugate symmetry sequence within a verification window, the verification window being smaller than the correlation window.

25. The MS of claim 23 wherein the frequency-domain correlator comprises:
a frequency-domain convolver to compute a frequency-domain circular convolution of the sequence of symbols; and
an inverse Fourier Transform (FT) module coupled to the convolver to compute an inverse Fourier Transform (FT) of the circular convolution to provide the symbol correlation.

26. The MS of claim 25 wherein the convolver comprises:
a first FT module to compute a first FT sequence of a first sequence in the sequence of symbols having a length of the correlation window;
a first complex conjugate operator to perform a re-ordering and a complex conjugate operation on a second sequence in the sequence of symbols;
a second FT module to compute a second FT sequence of the re-ordered and complex conjugated second sequence having a length of the correlation window;
a second complex conjugate operator to perform a complex conjugate operation on the second FT sequence; and
a multiplier to multiply the first FT sequence and the complex conjugated second FT sequence to provide the frequency-domain circular convolution.

27. The MS of claim 23 wherein the verifier comprises:
a peak detector to determine a maximum value of the symbol correlation at a maximum position;
an adder to compute a sum of K largest values of the symbol correlation, the K largest values having the maximum value at the maximum position;
a first comparator to compare the maximum value with a first threshold;
a second comparator to compare the sum with a second threshold;
a detector to detect the symbol as the preamble symbol at the maximum position if the maximum value exceeds the first threshold or if the sum exceeds the second threshold, and to detect the symbol as the data symbol if the maximum value does not exceed the first threshold and the sum does not exceed the second threshold.
